(19) United States
(12) Patent Application Publication
(10) Pub. No.: US 2013/0045378 A1
(43) Pub. Date: Feb. 21, 2013

(54) THIN-FILM TYPE LIGHT-ABSORBING FILM

(71) Applicants: Yasuaki INOUE, Osaka (JP); Shinsuke KAWAI, Osaka (JP); Miho FUYAMA, Osaka (JP)

(72) Inventors: Yasuaki INOUE, Osaka (JP); Shinsuke KAWAI, Osaka (JP); Miho FUYAMA, Osaka (JP)

(73) Assignee: NALUX CO., LTD., Osaka (JP)

(21) Appl. No.: 13/599,258

(22) Filed: Aug. 30, 2012

Related U.S. Application Data
(63) Continuation-in-part of application No. PCT/JP2010/005794, filed on Sep. 27, 2010.

(30) Foreign Application Priority Data
Mar. 3, 2010 (JP) 2010-047068

(51) Int. Cl. B32B 33/00

(52) U.S. Cl. 428/332

(57) ABSTRACT

Disclosed is a thin-film type light-absorbing film including multiple layers formed on a substrate. The multiple layers include: an iron oxide layer including triiron tetraoxide; and a dielectric layer including dielectric substance, wherein thickness of the iron oxide layer is 40 nanometers or more and the iron oxide layer and the dielectric layer form an anti-reflecting layer.

### CROSS REFERENCE TO RELATED APPLICATION

This is a Continuation-in-Part of International Patent Application No. PCT/JP2010/005794 filed Sep. 27, 2010, which designates the U.S. and was published under PCT Article 21(2) in English, and which claims priority form Japanese Patent Application No. 2010-047068, dated Mar. 3, 2010. The contents of these applications are hereby incorporated by reference.

### FIELD OF THE INVENTION

The present invention relates to a thin-film type light-absorbing film including multiple thin layers which absorb light.

### BACKGROUND ART

In image forming optical systems, there is a problem that flare and ghost are generated when the light receiving sensor receives stray light including light reflected on or transmitted through a lens-barrel and areas outside of an effective diameter of a lens. In order to prevent such stray light, there is such a measure as described below. That is, parts made of a material into which a light absorbing material is mixed are provided in areas outside of the effective diameter of the lens, and the lens-barrel is made from a material into which a light absorbing material is mixed. However, this measure requires a more complicated manufacturing process and higher manufacturing costs.

Further, another measure has been proposed in which light-absorbing thin films are provided in areas outside of an effective diameter of a lens and a lens-barrel. Conventionally, in order to form a thin-film type light-absorbing film including thin layers, metals such as titanium, nickel and chrome or metal oxides such as titanium oxide are used as light-absorbing thin layers (JP5-93811A, JP2007-206136A).

However, light-absorbing power of light-absorbing films using metal layers deteriorates over time after being formed under ordinary working conditions due to oxidation of the metal layers. Light-absorbing power of light-absorbing films using metal oxide films also deteriorates over time under ordinary working conditions due to oxidation or the like. Further, when conventional light-absorbing films using metal layers or metal oxide layers are used in a high temperature or a high humidity environment, the light-absorbing power will remarkably deteriorate over time.

For time deterioration in light-absorbing power of conventional thin-film type light-absorbing films including metals, a method has been proposed in which films containing metals are made to undergo heat treatment in an atmosphere including oxygen before use to artificially saturate a change in optical performance due to oxidation of the metals (JP2003-43211A). However, the method requires a complicated manufacturing process.

Thus, a thin-film type light-absorbing film including multiple thin layers which absorb light, which will not undergo time deterioration even when used in a high temperature or a high humidity environment and which can be made with a simple manufacturing process, has not been developed.

### PATENT DOCUMENTS

JP5-93811A
JP2007-206136A
JP2003-43211A

Accordingly, there is a need for a thin-film type light-absorbing film including multiple thin layers which absorb light, which will not undergo time deterioration even when used in a high temperature or a high humidity environment and which can be made with a simple manufacturing process.

### SUMMARY OF THE INVENTION

A thin-film type light-absorbing film according to the first aspect of the invention includes multiple layers formed on a substrate. The multiple layers include: an iron oxide layer including triiron tetraoxide; and a dielectric layer including dielectric substance, wherein thickness of the iron oxide layer is 40 nanometers or more and the iron oxide layer and the dielectric layer form an anti-reflecting layer.

According to the present aspect, the iron oxide layer including triiron tetraoxide absorbs light and the iron oxide layer and the dielectric layer form an anti-reflecting layer to prevent reflection of light. Triiron tetraoxide forms a very closely packed and chemically stable layer which is called black rust. Accordingly, by the use of a layer including triiron tetraoxide which has thickness of 40 nanometers or more, a thin-film type light-absorbing film which will not undergo time deterioration even when used in a high temperature or a high humidity environment and which can be made with a simple manufacturing process, is obtained.

A thin-film type light-absorbing film according to an embodiment of the first aspect of the invention can be used for light in the wavelength range from 400 to 2000 nanometers.

A thin-film type light-absorbing film according to the second aspect of the invention includes multiple layers formed on a substrate. The multiple layers include: an iron oxide layer including triiron tetraoxide; a dielectric layer including dielectric substance; and a metal layer including a metal, wherein thickness of the iron oxide layer is 40 nanometers or more, the metal layer is disposed closer to the substrate than the iron oxide layer and the dielectric layer and at least one of the iron oxide layer and the metal layer form an anti-reflecting layer.

According to the present aspect, the iron oxide layer including triiron tetraoxide and the metal layer absorb light and the dielectric layer and at least one of the iron oxide layer and the metal layer form an anti-reflecting layer to prevent reflection of light. Triiron tetraoxide forms a very closely packed and chemically stable layer which is called black rust. Accordingly, by the use of a layer made including triiron tetraoxide which has thickness of 40 nanometers or more, a thin-film type light-absorbing film which will not undergo time deterioration even when used in a high temperature or a high humidity environment and which can be made with a simple manufacturing process, is obtained. Further, by the use of a metal layer with attenuation coefficient which is much greater than that of the iron oxide layer in addition to the iron oxide layer as a layer having light-absorbing power, a total thickness of the thin-film type light-absorbing film can be made smaller than that in the case that a layer made of triiron tetraoxide alone is used. In this case, time deterioration of the metal layer can be prevented by arranging the metal layer such that the metal layer is closer to the substrate than the iron oxide layer.

A thin-film type light-absorbing film according to an embodiment of the second aspect of the invention can be used for light in the wavelength range from 400 to 2000 nanometers.

### BRIEF DESCRIPTION OF THE DRAWINGS

FIG. 1 shows an example of a thin-film type light-absorbing film used in an image forming optical system to prevent stray light;

FIG. 2 shows an example of a conventional stray light preventing mechanism without a thin-film type light-absorbing film;

FIG. 3 shows an example of a structure of a vacuum depositing apparatus for forming a thin-film type light-absorbing film according to the present invention;

FIG. 4 shows a relationship between wavelength and transmittance of a film made of triiron tetraoxide;

FIG. 5 shows a relationship between wavelength and transmittance of the film, obtained by simulation and that obtained by actual measurement in the case that the film is 1 micrometer thick;

FIG. 6 shows a construction of a thin-film type light-absorbing film of Example 1;

FIG. 7A shows relationships between wavelength in the visible light range and transmittance and reflectance of the thin-film type light-absorbing film of Example 1;

FIG. 7B shows a relationship between wavelength in the visible and infrared range and transmittance of the thin-film type light-absorbing film of Example 1;

FIG. 8 shows relationships between wavelength and transmittance of the thin-film type light-absorbing film of Example 1 after a high-temperature test and that after a high-humidity test;

FIG. 9 shows a construction of a thin-film type light-absorbing film of Example 2;

FIG. 10 shows a transmittance and reflectance versus wavelength graph before and after a high humidity test of the thin-film type light-absorbing film of Example 2;

FIG. 11 shows a transmittance and reflectance versus wavelength graph before and after a high temperature test of the thin-film type light-absorbing film of Example 2;

FIG. 12 shows a transmittance in a wider wavelength range of the thin-film type light-absorbing film of Example 2;

FIG. 13 shows a construction of a thin-film type light-absorbing film used to determine the lower limit of thickness of a triiron tetraoxide layer which is thick enough to prevent time deterioration in light-absorbing power;

FIG. 14 shows a relationship between thickness of the film made of triiron tetraoxide and (amount of change in absorptance/initial absorptance) for light of wavelength of 650 nanometers and that for light of wavelength of 750 nanometers; and

FIG. 15 is a flowchart illustrating a manufacturing process of the solvent ink including triiron tetraoxide.

### DETAILED DESCRIPTION

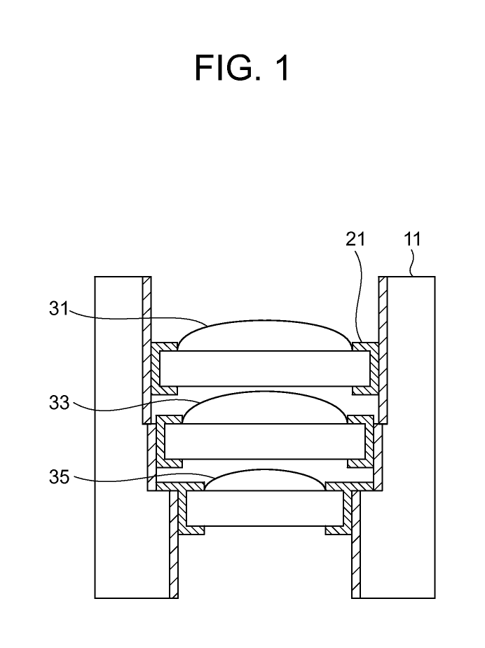

FIG. 1 shows an example of a thin-film type light-absorbing film used in an image forming optical system to prevent stray light. Thin-film type light-absorbing films 21 are provided in areas outside of effective diameters of lenses 31, 33 and 35 and in the inside surface of a lens-barrel 11.

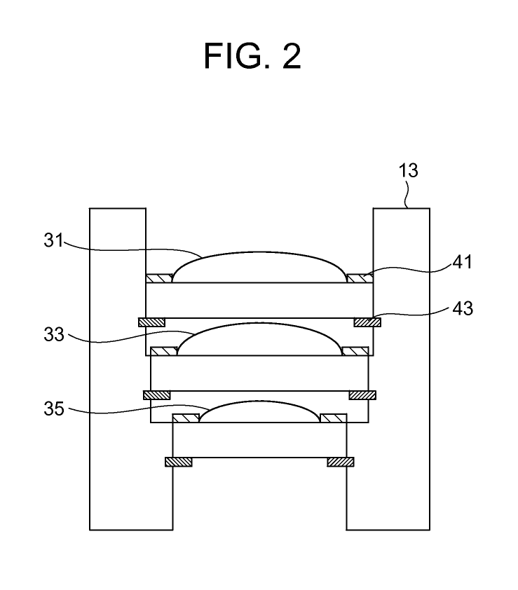

FIG. 2 shows an example of a conventional mechanism for preventing stray light without a thin-film type light-absorbing film. Parts 41 and 43 or the like into which a light absorbing material has been incorporated are provided in areas outside of effective diameters of lenses 31, 33 and 35. Further, a lens-barrel 13 is made of a material into which a light absorbing material has been incorporated. The mechanism for preventing stray light shown in FIG. 2 requires a greater number of parts than the case shown in FIG. 1 in which a thin-film type light-absorbing film is used. Further, in the case shown in FIG. 2, specific materials have to be used for the parts. Accordingly, a more complicated manufacturing process and higher manufacturing costs are required.

Performance usually required for a thin-film type light-absorbing film for preventing stray light is shown in Table 1.

TABLE 1

| | |
|---|---|
| Transmittance of light in the | 8% or less |
| wavelength range from 400 to 2000 | |
| nm | |
| Reflectance of light in the wavelength | 10% or less |
| range from 400 to 2000 nm | |
| Time deterioration | Time deterioration is within an |
| | allowable range in a high-temper- |
| | ature environment and in a high- |
| | humidity environment. |
| Film thickness | 10 micrometers or less |

The upper limit of transmittance and that of reflectance vary depending on performance specifications of an image forming optical system in which a thin-film type light-absorbing film is used. For usual image forming optical systems, the above-described values of the upper limits are sufficient. Description on environment with a high temperature and that with a high humidity will be given more specifically later.

A thin-film type light-absorbing film according to the present invention, may be formed by a vacuum deposition method.

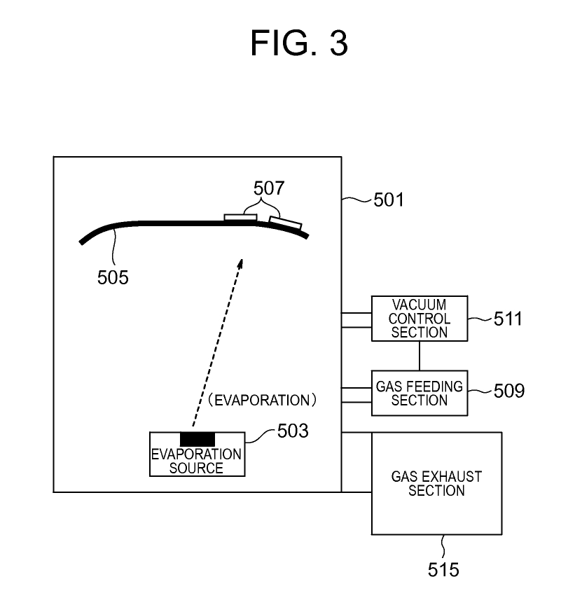

FIG. 3 shows an example of a structure of a vacuum depositing apparatus for forming a thin-film type light-absorbing film according to the present invention. In a vacuum chamber 501 of the vacuum depositing apparatus, a substrate holder 505 for a substrate 507 on which the thin-film type light-absorbing film is to be formed and an evaporation source 503 which vaporizes materials which form the thin-film type light-absorbing film are provided. To the vacuum chamber 501, a gas feeding section 509, a vacuum control section 511 and a gas exhaust section 515 are connected. The vacuum control section 511 detects degree of vacuum in the vacuum chamber 501 and adjusts a rate of gas fed to the vacuum chamber 501 by the gas feeding section 509.

In the present invention, a film made of triiron tetraoxide (Fe₃O₄) is used to prevent time deterioration in light-absorbing power of the film type light-absorbing film. Triiron tetraoxide is known as black rust and forms a very closely packed film which is chemically stable.

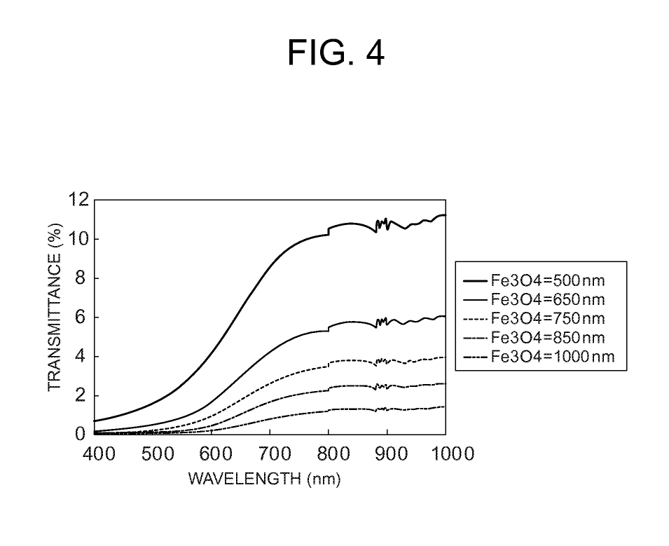

FIG. 4 shows a relationship between wavelength and transmittance of a film made of triiron tetraoxide of each film thickness value. When obtaining the above-mentioned relationship, refractive index and attenuation coefficient of triiron tetraoxide were obtained through experiments and then the above-mentioned relationship was obtained using a commercially available thin film designing program.

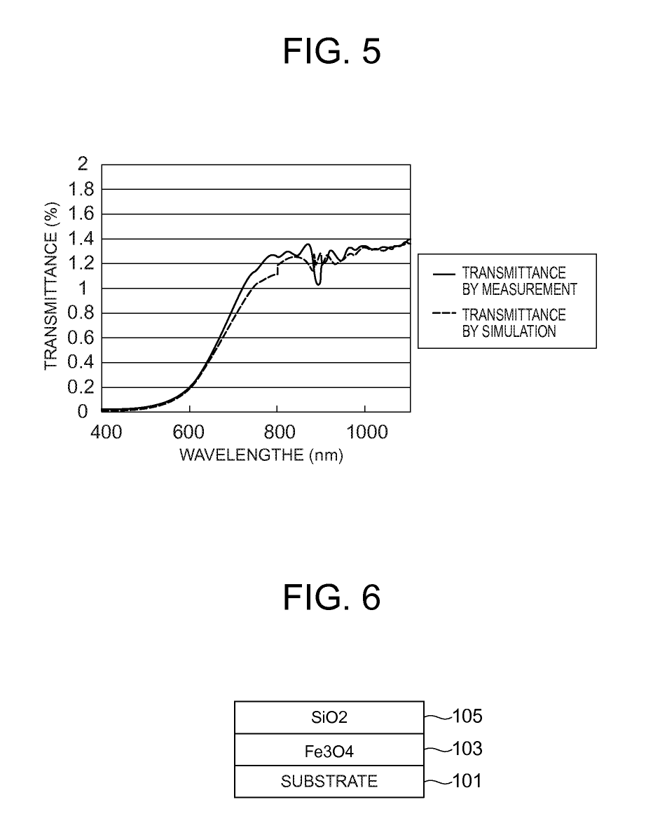

FIG. 5 shows a relationship between wavelength and transmittance of the film, obtained by simulation and that obtained by actual measurement in the case that the film is 1 micrometer thick. As shown in FIG. 5, the relationship obtained by calculation exactly agrees with the relationship obtained by measurement.

FIG. 4 shows that transmittance is 4% or less for light in a wavelength range from 400 to 1000 nanometers when thickness of the film made of triiron tetraoxide is 750 nanometers or more.

Examples of the present invention will be described below.

### Example 1

FIG. 6 shows a construction of a thin-film type light-absorbing film of Example 1. The thin-film type light-absorbing film of Example 1 is that in which a layer 103 made of triiron tetraoxide (Fe₃O₄) is formed on a substrate 101 and a layer made of silicon dioxide (SiO₂) is formed thereon.

Table 2 shows thickness of each layer of the thin-film type light-absorbing film of Example 1.

TABLE 2

| Layer No. | Material | Layer thickness (nm) |
|---|---|---|
| 2 | SiO₂ | 73 |
| 1 | Fe₃O₄ | 1000 |
| 0 | Plastic substrate | |

Material of the plastic substrate is ZEONEX480R, ZEONEX340R, PC (brand names) or the like.

Table 3 shows conditions under which the thin-film type light-absorbing film of Example 1 is produced by a vacuum deposit method.

TABLE 3

| Substrate temperature (° C.) | | Temperature is not controlled. |
|---|---|---|
| Ultimate vacuum (Pa) | | 2.00E−03 |
| Fe₃O₄ | Deposition rate | 4 Å/sec |
| | Degree of vacuum of | 1.20E−03 |
| | deposition (Pa) | |
| | Gas to be fed (Pa) | O₂ (1.0E−5) |
| | | (Very little gas is fed.) |
| SiO₂ | Deposition rate | 25 Å/sec |
| SiO₂ | Degree of vacuum of | 2.00E−03 |
| | deposition (Pa) | |
| | Gas to be fed (Pa) | O₂ (1.0E−5) |
| | | (Very little gas is fed.) |

In Table 3, E-03 represents 10⁻³ while E-05 represents 10⁻⁵.

In the thin-film type light-absorbing film of Example 1, the layer 103 made of triiron tetraoxide absorbs light. Further, the layer 105 made of silicon dioxide (SiO₂) which has a lower refractive index and the layer 103 made of triiron tetraoxide which has a higher refractive index form an anti-reflection layer which prevents reflection. In the present example, light enters the film from the side of the layer 105. In general, the layer 105 made of silicon dioxide (SiO₂) may be replaced with a dielectric film of magnesium fluoride (MgF₂), aluminium oxide (Al₂O₃) or the like. In order to reduce reflectance, the dielectric layer which has a lower refractive index should preferably be set closer to the light entry side than the layer which has a higher refractive index. In the text of specification and claims, a dielectric film or a dielectric layer means a film made of inorganic material, organic material or a mixture of them, including a metal oxide film.

In general, anti-reflection layers including a high-refractive index layer and a low-refractive index layer are disclosed in JP2002-328201A, JP2003-202405A and the like. Multi-layered films in which magnesium fluoride (MgF₂) or aluminium oxide (Al₂O₃) is used as a dielectric layer for an anti-reflection layer are disclosed in JP5-93811A, JP2007-206136A and the like, for example.

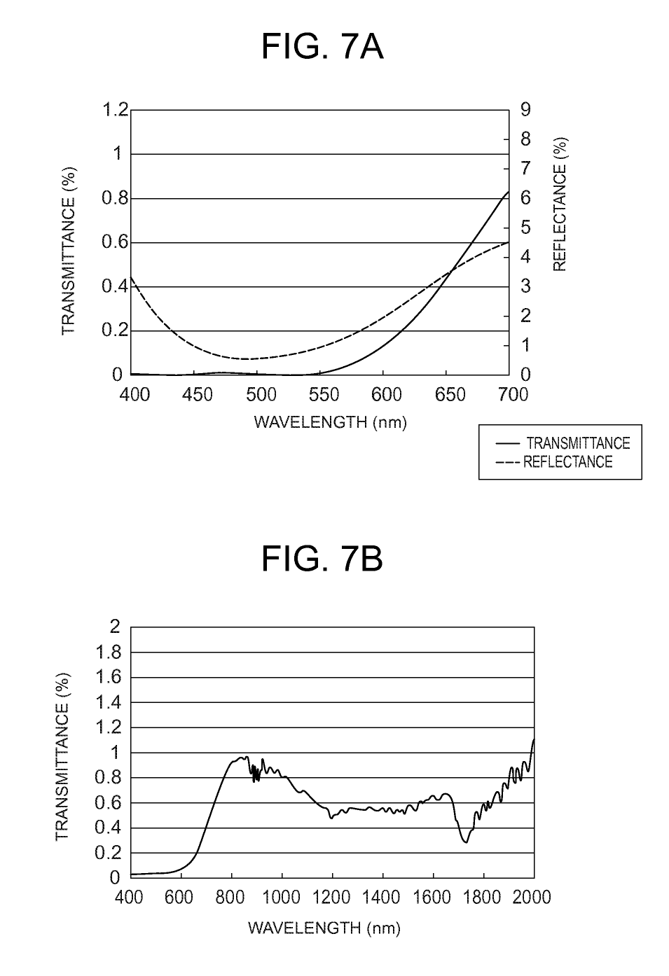

FIG. 7A shows relationships between wavelength in the visible light range and transmittance and reflectance of the thin-film type light-absorbing film of Example 1. For light in the wavelength range from 400 to 700 nanometers, transmittance is 1% or less while reflectance is 5% or less.

FIG. 7B shows a relationship between wavelength in the visible and infrared range and transmittance of the thin-film type light-absorbing film of Example 1. For light in the wavelength range from 400 to 2000 nanometers, transmittance is 1.2% or less. Measurement values in FIG. 7A slightly differ from corresponding values in FIG. 7B because of slightly different experimental conditions.

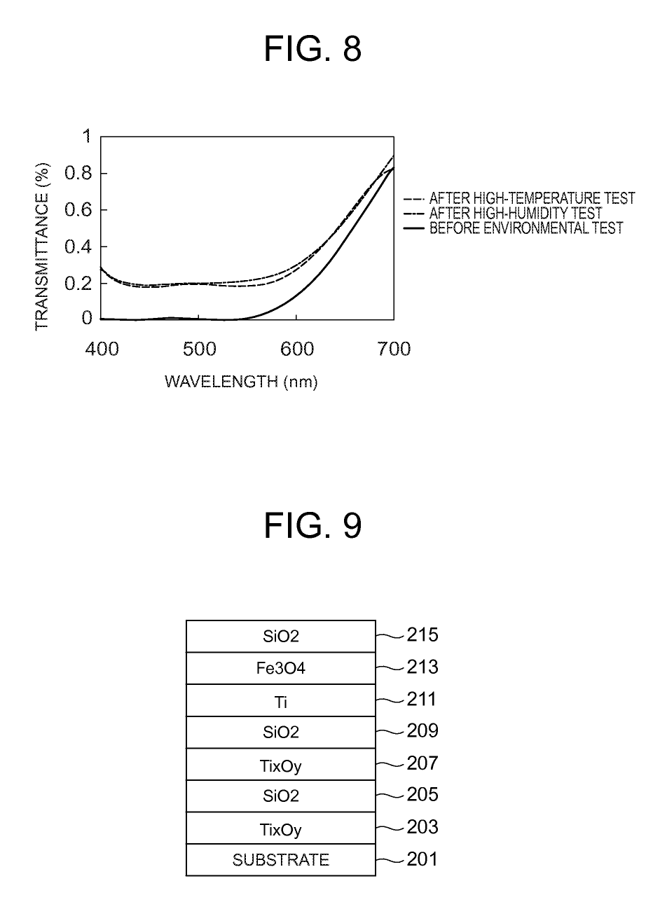

FIG. 8 shows relationship between wavelength and transmittance of the thin-film type light-absorbing film of Example 1 after a high-temperature test and that after a high-humidity test. In the high-temperature test, the light-absorbing film was set in an environment at temperature of 85° C. for a week. In the high-humidity test, the light-absorbing film was set in an environment at temperature of 60° C. and humidity of 90% for a week. Increase in transmittance after the high-temperature test and that after the high-humidity test are less than 0.3% in the wavelength range from 400 to 700 nanometers. Thus, the thin-film type light-absorbing film of Example 1 does not substantially deteriorate in light absorbing power when used in the high-temperature environment or in the high-humidity environment.

As described above, transmittance of the layer 103 made of triiron tetraoxide shows little time deterioration through the high-temperature test and the high-humidity test. The reason is considered to be that triiron tetraoxide forms a very tight and chemically stable film called black rust, as described above. Thus, the present invention is based on a new finding that a thin-film type light-absorbing film showing little time deterioration in light absorbing power can be obtained by the use of a layer of triiron tetraoxide.

### Example 2

FIG. 9 shows a construction of a thin-film type light-absorbing film of Example 2. The thin-film type light-absorbing film of Example 2 is that in which a layer 203 made of titanium oxide (TiₓO_{y}), a layer 205 made of silicon dioxide (SiO₂), a layer 207 made of titanium oxide (TiₓO_{y}), a layer 209 made of silicon dioxide (SiO₂), a layer 211 made of titanium (Ti), a layer 213 of triiron tetraoxide (Fe₃O₄) and a layer 215 made of silicon dioxide (SiO₂) are formed on a substrate 201 in the above-described order.

Table 4 shows thickness of each layer of the thin-film type light-absorbing film of Example 2.

TABLE 4

| Layer No. | Material | Layer thickness (nm) |
|---|---|---|
| 7 | SiO₂ | 76 |
| 6 | Fe₃O₄ | 180 |
| 5 | Ti | 50 |
| 4 | SiO₂ | 50 |
| 3 | TiₓO_{y} | 100 |
| 2 | SiO₂ | 50 |
| 1 | TiₓO_{y} | 100 |
| 0 | Plastic substrate | |

Material of the plastic substrate is ZEONEX480R, ZEONEX340R, PC (brand names) or the like.

Table 5 shows conditions under which the thin-film type light-absorbing film of Example 2 is produced by a vacuum deposit method.

TABLE 5

| Substrate temperature (° C.) | | Temperature is not controlled. |
|---|---|---|
| Ultimate vacuum (Pa) | | 2.00E−03 |
| Fe₃O₄ | Deposition rate | 4 Å/sec |
| | Degree of vacuum of | 1.20E−03 |
| | deposition (Pa) | |
| | Gas to be fed (Pa) | O₂ (1.0E−5) |
| | | (Very little gas is fed.) |
| SiO₂ | Deposition rate | 25 Å/sec |
| | Degree of vacuum of | 1.50E−02 |
| | deposition (Pa) | |
| | Gas to be fed (Pa) | Ar |
| TixOy | Deposition rate | 3.5 Å/sec |
| | Degree of vacuum of | 2.00E−02 |
| | deposition (Pa) | |
| | Gas to be fed (Pa) | O₂ |
| Ti | Deposition rate | 1.5 Å/sec |
| | Degree of vacuum of | 1.30E−02 |
| | deposition (Pa) | |
| | Gas to be fed (Pa) | Ar |

In Table 5, E-02 represents 10⁻² while E-03 represents 10⁻³.

In the thin-film type light-absorbing film of Example 2, the layer 213 made of triiron tetraoxide and the layer 211 made of titanium absorb light. Attenuation coefficient of titanium is ten times as large as that of triiron tetraoxide or more. Accordingly, a sum (230 nanometers) of film thickness value of the layer 213 and that of the layer 211 of Example 2 can be made smaller than the film thickness value (1000 nanometers) of the layer 103 of Example 1. As a result, the total film thickness of the thin-film type light-absorbing film can also be made smaller.

In designing a multi-layer film, refractive index and attenuation coefficient of a film containing a metal can be experimentally obtained and then such a relationship between wavelength and transmittance of the film containing the metal as shown in FIG. 4 can be obtained using a commercially available program for thin film designing.

In place of titanium, such a metal as chromium or nickel can be used. Attenuation coefficients of chromium and nickel are ten times as large as that of triiron tetraoxide or more and therefore the total film thickness of the thin-film type light-absorbing film can be reduced.

In Example 2, light enters the light-absorbing film from the side of the layer 215. In Example 2, the layer 213 made of triiron tetraoxide is placed at the farthest position from the substrate 201 among the layers 213, 211, 207 and 203 containing metals. Accordingly, oxygen which enters the light-absorbing film from the opposite side from the substrate 201 is intercepted by the layer 213 made of triiron tetraoxide. Accordingly, oxidation of the metal layer 211 is prevented and time deterioration in light-absorbing power of the metal layer 211 is prevented. The layers 203, 205, 207 and 209 also have some light-absorbing function. Time deterioration in light-absorbing power of these layers is similarly prevented.

From the results of the experiments at the beginning, it has been determined that thickness of the triiron tetraoxide layer which is enough to prevent time deterioration in light-absorbing power is 100 nanometers or more and that time deterioration cannot be sufficiently prevented when the thickness is less than the above-mentioned value.

Further, the layer 215 made of silicon dioxide (SiO₂) which has a lower refractive index and the layer 213 made of triiron tetraoxide which has a higher refractive index form a antireflection layer which prevents reflection of light. In the present example, light enters the light-absorbing film from the side of the layer 215. In general, the layer 215 made of silicon dioxide (SiO₂) can be replaced with a dielectric film made of aluminium oxide (Al₂O₃), magnesium fluoride (MgF₂) or the like. In order to reduce refractive index, the dielectric layer which has a lower refractive index should preferably be placed closer to the light entry side than the layer which has a higher refractive index.

In the present embodiment, adhesion between the layer 213 made of triiron tetraoxide (Fe₃O₄) and the substrate 201 can be enhanced by forming the dielectric layer s (203, 205, 207 and 209) and metal layer (211) between the layer 213 made of triiron tetraoxide (Fe₃O₄) and the substrate 201.

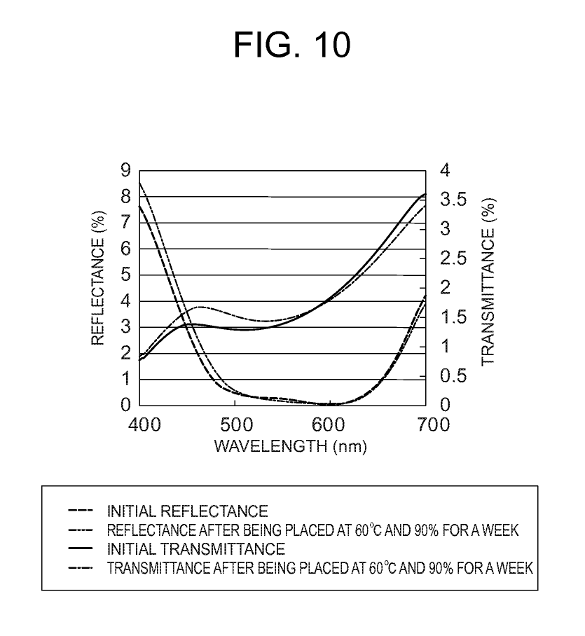

FIG. 10 shows a transmittance and reflectance versus wavelength graph before and after a high humidity test of the thin-film type light-absorbing film of Example 2. In the high humidity test, the light-absorbing film was placed in an environment at temperature of 60° C. and humidity of 90% for a week. Transmittance for light in a wavelength range from 400 to 700 nanometers is 4% or less before the high humidity test. Increase in transmittance after the high humidity test is 0.5% or less. Reflectance for light in a wavelength range from 400 to 700 nanometers is 8% or less before the high humidity test. Increase in reflectance after the high humidity test is 1.0% or less.

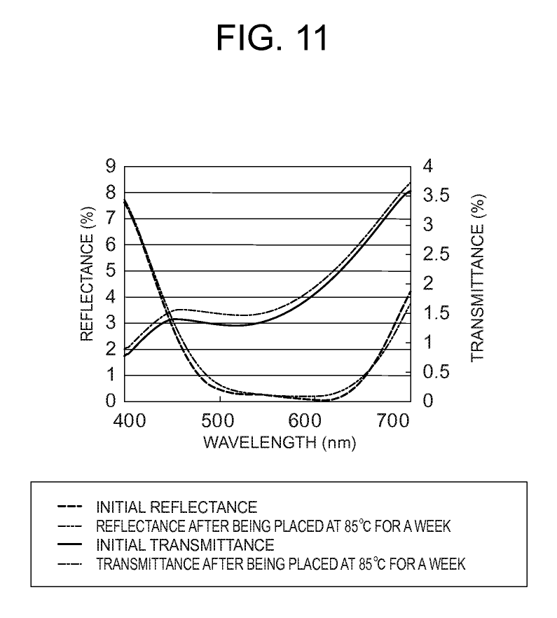

FIG. 11 shows a transmittance and reflectance versus wavelength graph before and after a high temperature test of the thin-film type light-absorbing film of Example 2. In the high temperature test, the light-absorbing film was placed in an environment at temperature of 85° C. for a week. Transmittance for light in a wavelength range from 400 to 700 nanometers is 4% or less before the high temperature test. Increase in transmittance after the high temperature test is 0.3% or less. Reflectance for light in a wavelength range from 400 to 700 nanometers is 8% or less before the high temperature test. Increase in reflectance after the high temperature test is 0.5% or less.

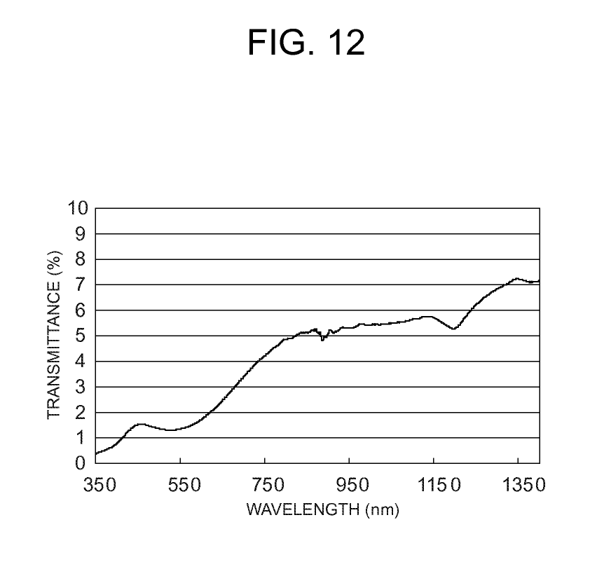

FIG. 12 shows a transmittance in a wider wavelength range of the thin-film type light-absorbing film of Example 2. Transmittance for light in a wavelength range from 400 to 1400 nanometers is 8% or less. Slight differences exist between a value in FIG. 10 and that in FIG. 12 and between a value in FIG. 11 and that in FIG. 12 because of slightly different experimental conditions.

In the present example, the metal layer 211 is used in addition to the layer 213 made of triiron tetraoxide as a layer having light-absorbing power. As a result, a total thickness of the thin-film type light-absorbing film can be made smaller than that in the case that a layer made of triiron tetraoxide alone is used. The reason is that attenuation coefficient of the metal is remarkably larger than that of triiron tetraoxide. In this case, the metal layer 211 is placed closer to the substrate 201 than the layer 213 made of triiron tetraoxide in order to prevent time deterioration of the metal layer 211. From the results of the experiments at the beginning, as described above, it has been determined that thickness of the triiron tetraoxide layer which is thick enough to prevent time deterioration in light-absorbing power is 100 nanometers or more and that the time deterioration cannot be prevented when the thickness is less than the above-mentioned value. The aspect of the invention which has been illustrated using Example 2 as an example is based on a new finding that by the use of the layer 213 of a predetermined thickness made of triiron tetraoxide and the metal layer 211, a thin-film type light-absorbing film can be obtained, which undergoes little time deterioration in performance and which is thinner than a thin-film type light-absorbing film which uses a layer made of triiron tetraoxide alone.

### Experiments to Determine the Lower Limit of Thickness of the Triiron Tetraoxide Layer

An experiment was carried out to more exactly determine the lower limit of thickness of the triiron tetraoxide layer which is thick enough to prevent time deterioration in light-absorbing power. As described above, the lower limit was previously determined to be 100 nanometers by the results of the experiments at the beginning.

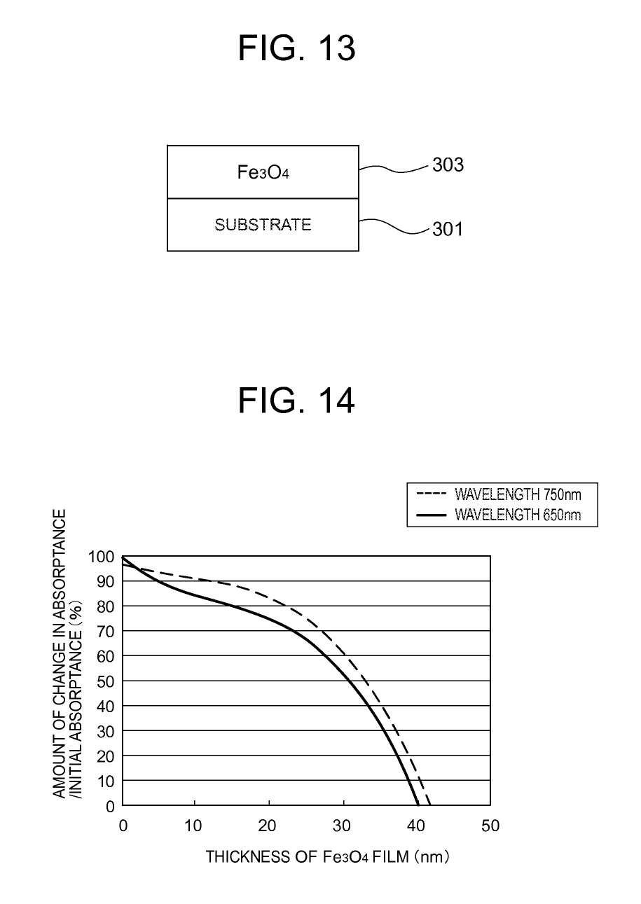

FIG. 13 shows a construction of a thin-film type light-absorbing film used to determine the lower limit of thickness of a triiron tetraoxide layer which is thick enough to prevent time deterioration in light-absorbing power. In the above-described thin-film type light-absorbing film, a layer 303 made of triiron tetraoxide (Fe₃O₄) is formed on a substrate 301.

Table 6 shows thickness of each layer of the above-described thin-film type light-absorbing film.

TABLE 6

| Layer No. | Material | Layer thickness (nm) |
|---|---|---|
| 1 | Fe₃O₄ | <50 nm |
| 0 | Plastic substrate | |

A material of the plastic substrate is ZEONEX480R, ZEONEX340R, PC (brand names) or the like.

More specifically, in the experiment, a layer made of triiron tetraoxide of each of various values of thickness less than 50 nanometers is formed on a substrate made of ZEONEX480R and initial absorptance was measured. Absorptance is defined by the following expression.

Absorptance=100−transmittance−reflectance (%)

After the above-described thin-film type light-absorbing film had been kept in a high-temperature and high-humidity environment at temperature of 85° C. and humidity of 85% for two weeks, absorptance was measured again. An amount of change in absorptance is defined by the following expression.

Amount of change in absorptance=Initial absorptance−Absorptance after having been kept in a high-temperature and high-humidity environment for two weeks (%)

FIG. 14 shows a relationship between thickness of the layer made of triiron tetraoxide and (amount of change in absorptance/initial absorptance) for light of wavelength of 650 nanometers and that for light of wavelength of 750 nanometers. The horizontal axis in FIG. 14 indicates thickness of the layer (film) made of triiron tetraoxide (in unit of nanometer) while the vertical axis in FIG. 14 indicates (amount of change in absorptance/initial absorptance) (in unit of %).

When thickness of the layer made of triiron tetraoxide is 40 nanometers or more, (amount of change in absorptance/initial absorptance) is zero and absorptance does not decrease from the initial absorptance after having been kept in a high-temperature and high-humidity environment for two weeks. This means that when thickness of the layer made of triiron tetraoxide is 40 nanometers or more, light-absorbing power of the layer made of triiron tetraoxide will not change in a high-temperature and high-humidity environment.

Accordingly, a light-absorbing film which will not undergo time deterioration in light absorbing power can be formed by combining a layer made of triiron tetraoxide of thickness of 40 nanometers or more, a dielectric layer and a metal layer if necessary.

A layer including triiron tetraoxide can also be formed by applying a solvent ink including triiron tetraoxide onto an object surface, for example, by an ink-jet printing device. The ink-jet printing device may include an ink injection nozzle using a piezo-electric element or an ultrasonic element and a moving device for moving the ink injection nozzle to an injection position. Further, the solvent ink including triiron tetraoxide can be applied onto the object surface by another method, for example by the use of a brush. Thickness of layers formed by the above-described method can be determined depending on required performance specifications in the range from 0.1 to 200 micrometers.

A dielectric layer including silicon dioxide, for example, or a metal layer can be formed by applying a solvent ink including silicon dioxide or the metal by the ink-jet printing device or by another method. Thickness of layers formed by the above-described method can be determined depending on required performance specifications in the range from 0.1 to 200 micrometers.

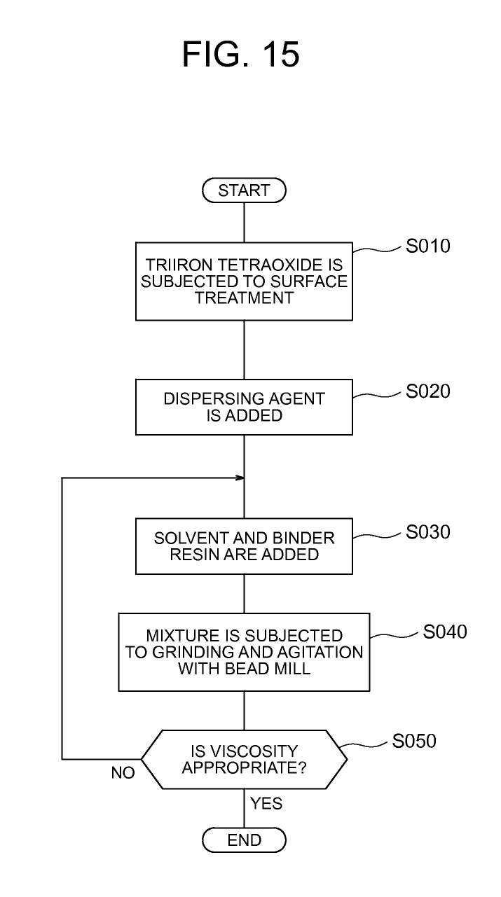

FIG. 15 is a flowchart illustrating an example of a manufacturing process of the solvent ink including triiron tetraoxide.

In step S010 of FIG. 15, triiron tetraoxide in powder is subjected to surface treatment using a silane coupling agent or a titanate coupling agent. In this case, (RO)₃—SiCH₂CH₂CH₂—X is used as a silane coupling agent. In the above-described chemical formula, (RO) represents methoxy group or the like, while X represents mercapto group, methacryloxy group, vinyl group, epoxy group or the like. By way of example, the average diameter of particles of the triiron tetraoxide powder is 0.001 to 50 micrometers. More specifically, by way of example, water and an acidity regulator such as sodium hydrogenarbonate are added to the silane coupling agent and the mixture is agitated. Then, triiron tetraoxide in powder is added to the mixture and the new mixture is agitated. By way of example, weight percentages of the silane coupling agent, the water, the acidity regulator and the triiron tetraoxide in powder are 1 to 30%, 1 to 30%, 0.1 to 20% and 50 to 85%, respectively. The mixture thus obtained is referred to as mixture A.

In step S020 of FIG. 15, a dispersing agent such as Solsperse 32000 (brand name) is added to mixture A. By way of example, weight percentages of mixture A and the dispersing agent are 30 to 90% and 10 to 70%, respectively. The mixture thus obtained is referred to as mixture B. Generally, the dispersing agent is a polymer dispersing agent having the main chain which is one of polyester, polyacryl, polyurethane, and polyamine and the side chain which is a polar group such as amino group, carboxyl group, sulfone group and hydroxyl group.

In step S030 of FIG. 15, a solvent (solvents) and a binder resin (binder resins) are added to mixture B. More specifically, by way of example, the solvents are diethylene glycol diethyl ether, tetraethylene-glycol and γ-butyrolactone and the binder resins are an acrylic resin and Paraloid B60 (brand name). By way of example, weight percentages of mixture B, the solvents and the binder resins are 50 to 60%, 40 to 50% and 1 to 40%, respectively. Further, additives such as anti-oxidizing agents, stabilization agent such as ultraviolet absorbing agents, and surface active agents can be added to mixture B. The mixture thus obtained is referred to as mixture C. Generally, in mixture C, weight percentages of mixture A and the other components (the dispersing agent, the solvent, the binder resins and the additives) are 10 to 90% and 10 to 90%, respectively. In general, the solvents are glycols, glycol ethers, cyclic ethers, δ-lactones, lactones, polyalcohol, lower alcohol, esters, ketones and derivatives of polyalcohol. In general, the binder resins are acrylic resins, vinyl chloride/vinyl acetate base copolymer resin, vinyl base resin and polyester base resin.

In step S040 of FIG. 15, mixture C is subjected to grinding and agitation by the use of a bead mill.

In step S050 of FIG. 15, degree of viscosity of mixture C is measured and it is determined whether a measured value of degree of viscosity is within an appropriate range. By way of example, the appropriate range is from 1×10⁻⁵ to 5 Pascal·second. If the measured value of degree of viscosity is within the appropriate range, the process is terminated. If the measured value of degree of viscosity is not within the appropriate range, the process goes to step S030.

It should be noted that FIG. 15 merely shows an example of a manufacturing process of the solvent ink including triiron tetraoxide and that depending on the situation, some of the steps shown in FIG. 15 are not required for manufacturing the solvent ink including triiron tetraoxide.

The solvent ink including silicon dioxide or a metal can be produced by a method similar to that shown in FIG. 15. In the method, silicon dioxide or the metal is used in place of triiron tetraoxide.

The thin-film type light-absorbing film according to the present invention can be used as coating not only in optical systems but also in other fields, such as a heating element including a blackbody furnace, an electromagnetic-wave-shielding element, an electric conductive element, a part for appearance beauty such as a design surface and the like.

What is claimed is:

1. A thin-film type light-absorbing film including multiple layers formed on a substrate, the multiple layers comprising:
an iron oxide layer including triiron tetraoxide; and
a dielectric layer including dielectric substance,
wherein thickness of the iron oxide layer is 40 nanometers or more and the iron oxide layer and the dielectric layer form an anti-reflecting layer.

2. A thin-film type light-absorbing film according to claim 1, which can be used for light in the wavelength range from 400 to 2000 nanometers.

3. A thin-film type light-absorbing film including multiple layers formed on a substrate, the multiple layers comprising:
an iron oxide layer including triiron tetraoxide;
a dielectric layer including dielectric substance; and
a metal layer including a metal,
wherein thickness of the iron oxide layer is 40 nanometers or more, the metal layer is disposed closer to the substrate than the iron oxide layer and the dielectric layer and at least one of the iron oxide layer and the metal layer form an anti-reflecting layer.

4. A thin-film type light-absorbing film according to claim 3, which can be used for light in the wavelength range from 400 to 2000 nanometers.
